(19) United States
(12) Patent Application Publication
(10) Pub. No.: US 2024/0156294 A1
(43) Pub. Date: May 16, 2024

(54) Cooking Appliance

(71) Applicant: Noel Nyirenda, Sanford, ME (US)

(72) Inventor: Noel Nyirenda, Sanford, ME (US)

(21) Appl. No.: 17/984,901

(22) Filed: Nov. 10, 2022

(51) Int. Cl. A47J 27/00; A47J 27/21

(52) U.S. Cl. CPC A47J 27/004; A47J 27/002; A47J 27/21008

(57) ABSTRACT

A cooking appliance for mixing and cooking ingredients for preparing food items, such as fufu, includes a housing and a shell. The housing comprises a back, a base, and a top. The base is coupled to and extends from a lower end of the back. A plate is coupled to an upper surface of the base and a heating element is coupled to the plate. The top is hingedly coupled to and extends from an upper end of the back. A motor is positioned in the top. The top is configured to pivot to an open configuration to position the shell upon the plate. A whisk that is couplable to the motor is inserted into the shell, and ingredients that are positioned in the shell, as the top is pivoted to a closed configuration. The motor rotates the whisk to mix the ingredients and the heating element heats the ingredients to prepare food, such as fufu.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### Field of the Invention.

### Description of Related Art including information disclosed under 37 CFR 1.97 and 1.98.

The disclosure and prior art relates to cooking appliances and more particularly pertains to a new cooking appliance for mixing and cooking ingredients for preparing food items, such as fufu.

### BRIEF SUMMARY OF THE INVENTION

An embodiment of the disclosure meets the needs presented above by generally comprising a housing and a shell. The housing comprises a back, a base, and a top. The base is coupled to and extends from a lower end of the back. A plate is coupled to an upper surface of the base and a heating element is coupled to the plate. The top is hingedly coupled to and extends from an upper end of the back. A motor is positioned in the top. The top is configured to pivot to an open configuration to position the shell upon the plate. A whisk that is couplable to the motor is inserted into the shell, and ingredients that are positioned in the shell, as the top is pivoted to a closed configuration. The motor rotates the whisk to mix the ingredients and the heating element heats the ingredients to prepare food, such as fufu.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a cooking appliance according to an embodiment of the disclosure.

FIG. 2 is a bottom view of an embodiment of the disclosure.

FIG. 3 is a front view of an embodiment of the disclosure.

FIG. 4 is a side view of an embodiment of the disclosure.

FIG. 5 is an in-use view of an embodiment of the disclosure.

### DETAILED DESCRIPTION OF THE INVENTION

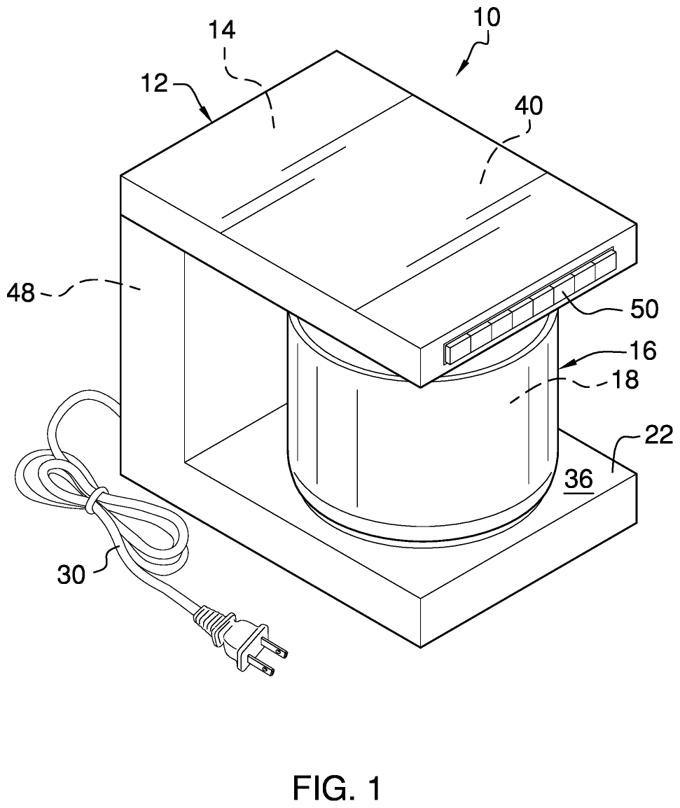

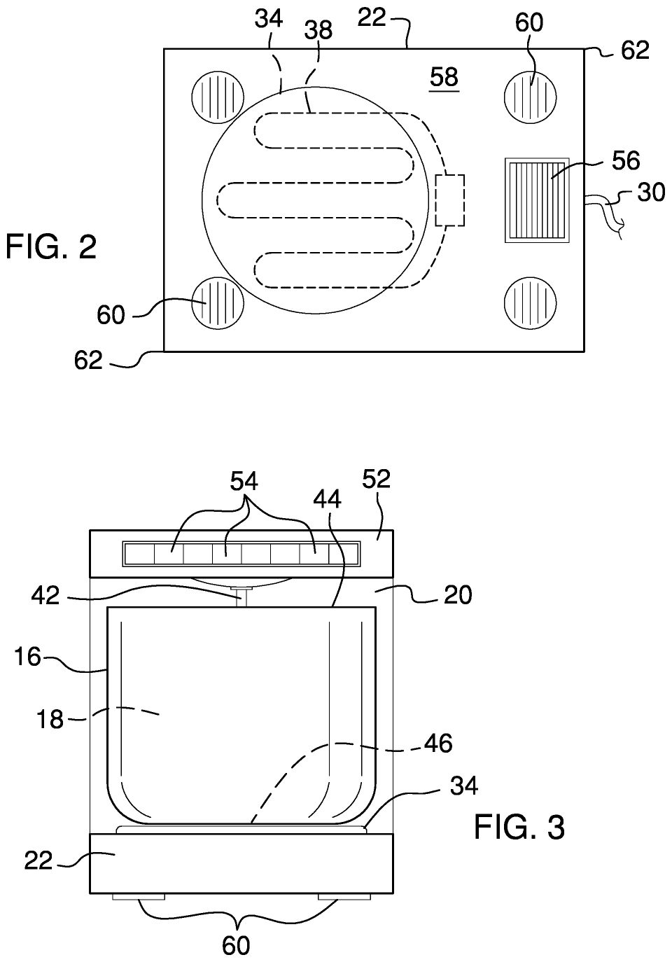

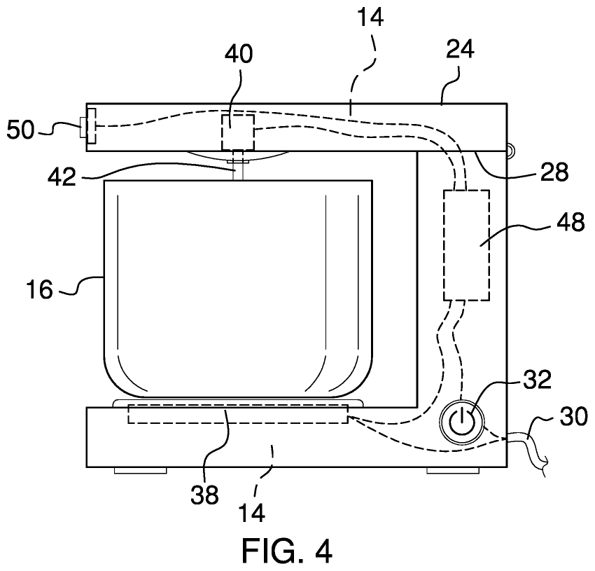

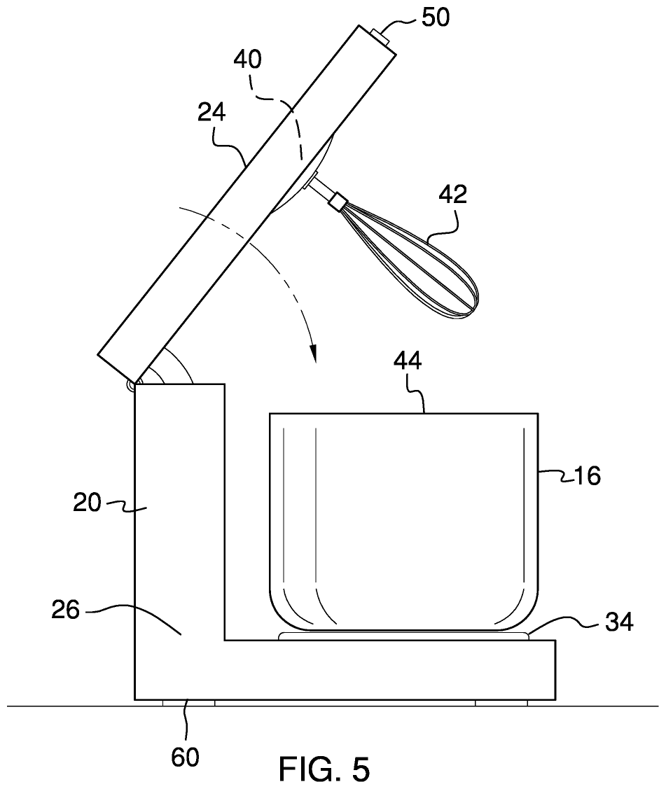

With reference now to the drawings, and in particular to FIGS. 1 through 5 thereof, a new cooking appliance embodying the principles and concepts of an embodiment of the disclosure and generally designated by the reference numeral 10 will be described.

As best illustrated in FIGS. 1 through 5, the cooking appliance 10 generally comprises a housing 12 that defines an internal space 14 and a shell 16 that defines an interior space 18. The housing 12 comprises a back 20, a base 22, and a top 24. The base 22 is coupled to and extends from a lower end 26 of the back 20. The top 24 is hingedly coupled to and extends from an upper end 28 of the back 20. The top 24 is configured to reversibly pivot from a closed configuration to an open configuration. In the closed configuration, the top 24 is substantially parallel to the base 22. In the open configuration, the top 24 extends transversely from the back 20.

A cord 30 is coupled to and extends from the housing 12. The cord 30 is configured to couple to a source of electrical current. In one embodiment, the cord 30 is configured to couple to a source of alternating current. In another embodiment, the cord 30 extends from the back 20 proximate to the lower end 26.

A switch 32 is coupled to the housing 12. The switch 32 is operationally coupled to the cord 30. In one embodiment, the switch 32 is positioned on the back 20 proximate to the lower end 26.

A plate 34 is coupled to an upper surface 36 of the base 22. In one embodiment, the plate 34 comprises metal. In another embodiment, the plate 34 is circularly shaped. A heating element 38 is coupled to the plate 34 and is positioned in the base 22. The heating element 38 is operationally coupled to the switch 32. The switch 32 is positioned to selectively couple the heating element 38 to the cord 30 to heat the plate 34.

A motor 40 is coupled to and positioned in the top 24. The motor 40 is operationally coupled to the switch 32. A whisk 42 is reversibly couplable to the motor 40. The switch 32 is positioned to selectively couple the motor 40 to the cord 30 to rotate the whisk 42.

The shell 16 has an upper face 44 that is open. The shell 16 is configured to position ingredients, such as flour and water, through the upper face 44 into the interior space 18. The top 24 is configured to pivot to the open configuration to position the housing 12 to place the shell 16 upon the plate 34. The whisk 42 is positioned to be inserted through the upper face 44 of the shell 16 into the interior space 18 as the top 24 is pivoted from the open configuration to the closed configuration. The switch 32 is positioned to couple the motor 40 and the heating element 38 to the cord 30. The motor 40 is positioned to rotate the whisk 42 to mix the ingredients. The heating element 38 is positioned to heat the plate 34 so that the plate 34 heats the shell 16 and the ingredients to prepare food, such as fufu. The shell 16 has a bottom 46. In one embodiment, the bottom 46 is substantially complementary to the plate 34.

A microprocessor 48 is coupled to the housing 12 and is positioned in the internal space 14. The microprocessor 48 is operationally coupled to the switch 32, the motor 40, and the heating element 38. The microprocessor 48 is configured to selectively couple the motor 40 and the heating element 38 to the cord 30. In one embodiment, the microprocessor 48 is positioned in the back 20.

A controller 50 is coupled to the housing 12. The controller 50 is operationally coupled to the microprocessor 48. The controller 50 is configured to input commands into the microprocessor 48 so that the microprocessor 48 is positioned to control a rotational speed of the motor 40, a heating level of the heating element 38, and a time to decouple the heating element 38 from the cord 30. In one embodiment, the controller 50 is coupled to the top 24 proximate to a front edge 52 of the top 24. In another embodiment, the controller 50 comprises a plurality of buttons 54. Each button 54 is configured to be depressed to input a respective cooking regimen into the microprocessor 48 so that the plurality of buttons 54 has a variety of cooking regimens. In yet another embodiment, the plurality of buttons 54 comprises eight buttons 54.

In one embodiment, a vent 56 is positioned through a lower surface 58 of the base 22. The vent 56 is configured to ventilate the internal space 14. In another embodiment, a plurality of feet 60 is coupled to the lower surface 58. The feet 60 are configured to stabilize the housing 12 and the shell 16 on a substantially horizontal surface. In yet another embodiment, the plurality of feet 60 comprises four feet 60 positioned singly proximate to each corner 62 of the base 22.

In use, the shell 16 is configured to position the ingredients, such as the flour and the water, through the upper face 44 into the interior space 18. The top 24 is configured to pivot to the open configuration to position the housing 12 to place the shell 16 upon the plate 34. The whisk 42 is positioned to be inserted through the upper face 44 of the shell 16 into the interior space 18 as the top 24 is pivoted from the open configuration to the closed configuration. The controller 50 is positioned on the housing 12 so that each button 54 is configured to be depressed to input the respective cooking regimen into the microprocessor 48. The microprocessor 48 is positioned to control the rotational speed of the motor 40 to rotate the whisk 42 to mix the ingredients. The microprocessor 48 also is positioned to control the heating level of the heating element 38 to heat the plate 34. The plate 34 is positioned to heat the shell 16 and the ingredients to prepare the food, such as the fufu. The microprocessor 48 also is positioned to control the time to decouple the heating element 38 from the cord 30.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A cooking appliance comprising:
a housing defining an internal space, said housing comprising:
a back,
a base coupled to and extending from a lower end of said back, and
a top hingedly coupled to extending from an upper end of said back, wherein said top is positioned on said back such that said top is configured for reversibly pivoting from a closed configuration, wherein said top is substantially parallel to said base, and an open configuration, wherein said top extends transversely from said back;
a cord coupled to and extending from said housing, said cord being configured for coupling to a source of electrical current;
a switch coupled to said housing, said switch being operationally coupled to said cord;
a plate coupled to an upper surface of said base;
a heating element coupled to said plate and positioned in said base, said heating element being operationally coupled to said switch, wherein said heating element is positioned on said plate such that said switch is positioned for selectively coupling said heating element to said cord for heating said plate;
a motor coupled to and positioned in said top, said motor being operationally coupled to said switch;
a whisk reversibly couplable to said motor, wherein said motor is positioned in said top such that said switch is positioned for selectively coupling said motor to said cord for rotating said whisk;
a shell defining an interior space, said shell having an upper face, said upper face being open; and
wherein said upper face is positioned in said shell such that said shell is configured for positioning ingredients, such as flour and water, through said upper face into said interior space, wherein said top is positioned on said back such that said top is configured for pivoting to the open configuration positioning said housing for placing said shell upon said plate, wherein said whisk is positioned in said motor such that said whisk is positioned for inserting through said upper face of said shell into said interior space as said top is pivoted from the open configuration to the closed configuration, wherein said switch is positioned on said housing such that said switch is positioned for coupling said motor and said heating element to said cord such that said motor is positioned for rotating said whisk for mixing the ingredients and such that said heating element is positioned for heating said plate such that said plate is positioned for heating said shell and the ingredients for preparing food, such as fufu.

2. The appliance of claim 1, further including said cord being configured for coupling to a source of alternating current.

3. The appliance of claim 1, further including said cord extending from said back proximate to said lower end.

4. The appliance of claim 1, further including said switch being positioned on said back proximate to said lower end.

5. The appliance of claim 1, further including said plate comprising metal.

6. The appliance of claim 1, further including said plate being circularly shaped.

7. The appliance of claim 1, further including said shell having a bottom, said bottom being substantially complementary to said plate.

8. The appliance of claim 1, further comprising:
a microprocessor coupled to said housing and positioned in said internal space, said microprocessor being operationally coupled to said switch, said motor, and said heating element, said microprocessor being configured for selectively coupling said motor and said heating element to said cord;
a controller coupled to said housing, said controller being operationally coupled to said microprocessor, said controller being configured for inputting commands into said microprocessor; and
wherein said microprocessor is positioned for controlling a rotational speed of said motor, a heating level of said heating element, and a time for decoupling of said heating element from said cord.

9. The appliance of claim 8, further including said microprocessor being positioned in said back.

10. The appliance of claim 8, further including said controller being coupled to said top proximate to a front edge of said top.

11. The appliance of claim 8, further including said controller comprising a plurality of buttons, each said button being configured for depressing for inputting a respective cooking regimen into said microprocessor such that said plurality of buttons has a variety of cooking regimens.

12. The appliance of claim 11, further including said plurality of buttons comprising eight said buttons.

13. The appliance of claim 1, further including a vent positioned through a lower surface of said base, wherein said vent is positioned in said base such that said vent is configured for ventilating said internal space.

14. The appliance of claim 1, further including a plurality of feet coupled to a lower surface of said base, wherein said feet are positioned on said base such that said feet configured for stabilizing said housing and said shell on a substantially horizontal surface.

15. The appliance of claim 14, further including said plurality of feet comprising four said feet positioned singly proximate to each corner of said base.

16. A cooking appliance comprising:
a housing defining an internal space, said housing comprising:
a back,
a base coupled to and extending from a lower end of said back, and
a top hingedly coupled to extending from an upper end of said back, wherein said top is positioned on said back such that said top is configured for reversibly pivoting from a closed configuration, wherein said top is substantially parallel to said base, and an open configuration, wherein said top extends transversely from said back;
a cord coupled to and extending from said housing, said cord being configured for coupling to a source of electrical current, said cord being configured for coupling to a source of alternating current, said cord extending from said back proximate to said lower end;
a switch coupled to said housing, said switch being operationally coupled to said cord, said switch being positioned on said back proximate to said lower end;
a plate coupled to an upper surface of said base, said plate comprising metal, said plate being circularly shaped;
a heating element coupled to said plate and positioned in said base, said heating element being operationally coupled to said switch, wherein said heating element is positioned on said plate such that said switch is positioned for selectively coupling said heating element to said cord for heating said plate;
a motor coupled to and positioned in said top, said motor being operationally coupled to said switch;
a whisk reversibly couplable to said motor, wherein said motor is positioned in said top such that said switch is positioned for selectively coupling said motor to said cord for rotating said whisk;
a shell defining an interior space, said shell having an upper face, said upper face being open, wherein said upper face is positioned in said shell such that said shell is configured for positioning ingredients, such as flour and water, through said upper face into said interior space, wherein said top is positioned on said back such that said top is configured for pivoting to the open configuration positioning said housing for placing said shell upon said plate, wherein said whisk is positioned in said motor such that said whisk is positioned for inserting through said upper face of said shell into said interior space as said top is pivoted from the open configuration to the closed configuration, wherein said switch is positioned on said housing such that said switch is positioned for coupling said motor and said heating element to said cord such that said motor is positioned for rotating said whisk for mixing the ingredients and such that said heating element is positioned for heating said plate such that said plate is positioned for heating said shell and the ingredients for preparing food, such as fufu, said shell having a bottom, said bottom being substantially complementary to said plate;
a microprocessor coupled to said housing and positioned in said internal space, said microprocessor being operationally coupled to said switch, said motor, and said heating element, said microprocessor being configured for selectively coupling said motor and said heating element to said cord, said microprocessor being positioned in said back;
a controller coupled to said housing, said controller being operationally coupled to said microprocessor, said controller being configured for inputting commands into said microprocessor such that said microprocessor is positioned for controlling a rotational speed of said motor, a heating level of said heating element, and a time for decoupling of said heating element from said cord, said controller being coupled to said top proximate to a front edge of said top, said controller comprising a plurality of buttons, each said button being configured for depressing for inputting a respective cooking regimen into said microprocessor such that said plurality of buttons has a variety of cooking regimens, said plurality of buttons comprising eight said buttons;
a vent positioned through a lower surface of said base, wherein said vent is positioned in said base such that said vent is configured for ventilating said internal space;
a plurality of feet coupled to said lower surface of said base, wherein said feet are positioned on said base such that said feet configured for stabilizing said housing and said shell on a substantially horizontal surface, said plurality of feet comprising four said feet positioned singly proximate to each corner of said base; and
wherein said upper face is positioned in said shell such that said shell is configured for positioning ingredients, such as flour and water, through said upper face into said interior space, wherein said top is positioned on said back such that said top is configured for pivoting to the open configuration positioning said housing for placing said shell upon said plate, wherein said whisk is positioned in said motor such that said whisk is positioned for inserting through said upper face of said shell into said interior space as said top is pivoted from the open configuration to the closed configuration, wherein said controller is positioned on said housing such that each said button is configured for depressing for inputting a respective cooking regimen into said microprocessor such that said microprocessor is positioned for controlling the rotational speed of said motor for rotating said whisk for mixing the ingredients, the heating level of said heating element for heating said plate such that said plate is positioned for heating said shell and the ingredients for preparing the food, such as the fufu, and the time for decoupling of said heating element from said cord.
